(19) United States
(12) Patent Application Publication
(10) Pub. No.: US 2021/0086892 A1
(43) Pub. Date: Mar. 25, 2021

(54) DEVICE FOR DEPLOYING A RETRACTABLE LANDING GEAR

(71) Applicant: BLACKWING SWEDEN AB, ESLÖV (SE)

(72) Inventors: Niklas ANDERBERG, BJÄRRED (SE); Tomas NORLANDER, LUND (SE); Harald AHLBERG, LUND (SE)

(21) Appl. No.: 16/498,961

(22) PCT Filed: Mar. 29, 2018
(86) PCT No.: PCT/SE2018/050342

§ 371 Date: Sep. 27, 2019

(30) Foreign Application Priority Data
Mar. 30, 2017 (SE) 1750387-1

(51) Int. Cl. B64C 25/24; F16H 21/44; F16H 1/22

(52) U.S. Cl. CPC B64C 25/24; F16H 1/225; F16H 21/44

(57) ABSTRACT

A device configured to deploy a retractable landing gear having a main landing gear and a secondary landing gear is provided. The device includes an electrical motor in driving connection with a drive shaft connecting the secondary landing gear with the main landing gear. A retractable landing gear including the device and an aircraft having the landing gear are also provided.

### TECHNICAL FIELD

The present invention related to a retractable landing gear. In particular, the present invention relates to a device for deploying a retractable landing gear for aircraft.

### BACKGROUND

Aircrafts are typically provided with a landing gear retraction system. One such system, used with e.g. Cessna R182, is a hydraulically powered system having one nose gear actuator and two main gear actuators controlling main gear struts via a sector gear arrangement. One hydraulic system is provided for the nose gear, and a separate hydraulic system is provided for the main gear. When moving a gear selector handle, hydraulic fluid is supplied to the actuators to drive the nose gear and main gears.

As is evident the above-described system is rather complex, requiring several actuators, each requiring associated hydraulics for proper operation. Moreover the overall weight of such system makes it unsuitable for low-weight applications such as light sport aircraft. In view of these drawbacks it would be desirable to provide a more simple and low-weight retractable landing gear solution.

### SUMMARY

The inventor has realized that the object of solving the above-mentioned drawbacks may be achieved by an electrically operated landing gear retraction device whereby the nose gear is connected to the main gears by means of a drive shaft.

According to a first aspect a device for deploying a retractable landing gear having a main gear and a secondary gear is provided. The device comprises an electrical motor in driving connection with a drive shaft connecting the secondary gear with said main gear.

According to another aspect a retractable landing gear comprising the aforementioned device, a main gear, and a secondary gear is provided.

According to further aspect an aircraft comprising the aforementioned landing gear is provided.

### BRIEF DESCRIPTION OF DRAWINGS

Embodiments of the present invention will be described in the following, reference being made to the appended drawings, in which:

FIG. 1a is an isometric view of an aircraft having a retractable landing gear arranged in an extended position;

FIG. 1b is an isometric view of an aircraft having a retractable landing gear arranged in an extended position, and wherein a section of the airframe has been removed to better show the retractable landing gear assembly;

FIG. 2a is an isometric view of the aircraft shown in FIG. 1, having the landing gear arranged in a position close to a fully retracted position;

FIG. 2b is an isometric view of the aircraft shown in FIG. 2a, wherein a section of the airframe has been removed to better show the retractable landing gear assembly;

FIG. 3a is an isometric view of the aircraft shown in FIG. 1 having the landing gear arranged in a fully retracted position;

FIG. 3b is an isometric view of the aircraft shown in FIG. 3a, wherein a section of the airframe has been removed to better show the retractable landing gear assembly;

FIGS. 4a to 4d respectively show a side view of a retractable landing gear;

FIGS. 5a to 5d respectively show a side view of a secondary retractable landing gear at different retracting/extracting positions;

FIGS. 6a to 6d respectively show a side view of a main retractable landing gear at different retracting/extracting positions; and

FIGS. 7a to 7d respectively show a top view of a main gear of a retractable landing gear according to an embodiment, wherein the main gear being arranged in a fully extended position in FIG. 7a, and FIGS. 7b and 7c respectively show the main gear at two intermediate positions, whereas FIG. 7d is a top view of the main gear shown arranged in a fully retracted position.

### DETAILED DESCRIPTION

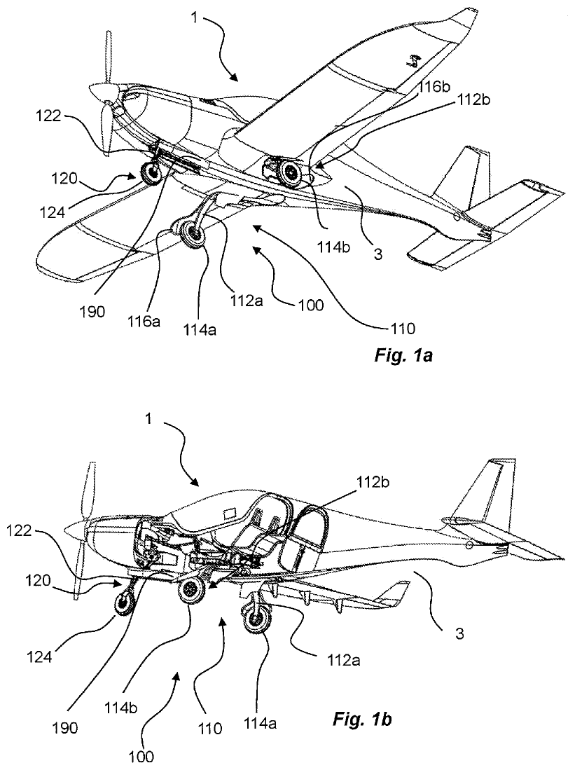

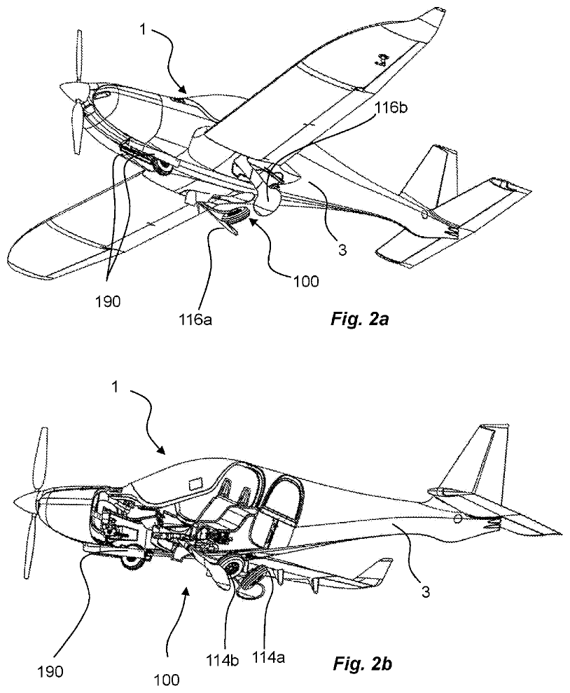

Starting in FIGS. 1a and 1b an aircraft 1 is shown. The aircraft 1, here represented as a light weight sport aircraft, is provided with a retractable landing gear 100. The landing gear 100 comprises a main gear 110 having two spaced-apart main gear legs 112a-b, each main gear leg 112a-b carrying at least one wheel 114. The landing gear 100 further includes a secondary gear 120, here in the form of a nose gear, which nose gear 120 has a secondary gear leg 122 carrying at least one wheel 124. It should be noted that secondary gear 120 could also be a tail gear.

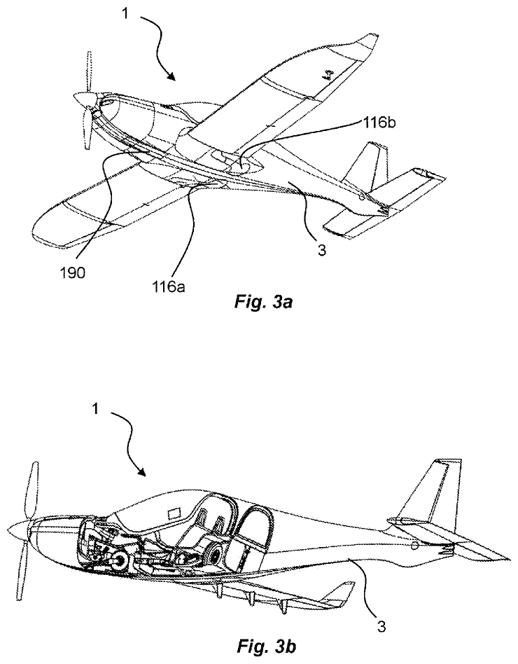

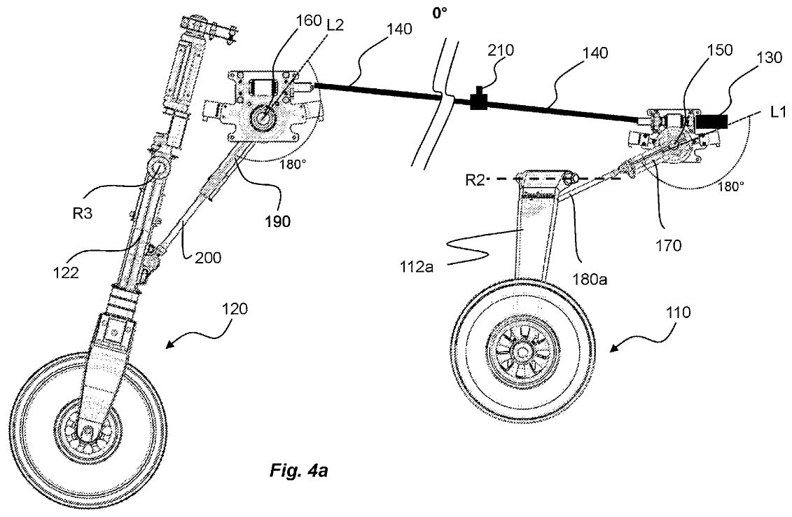

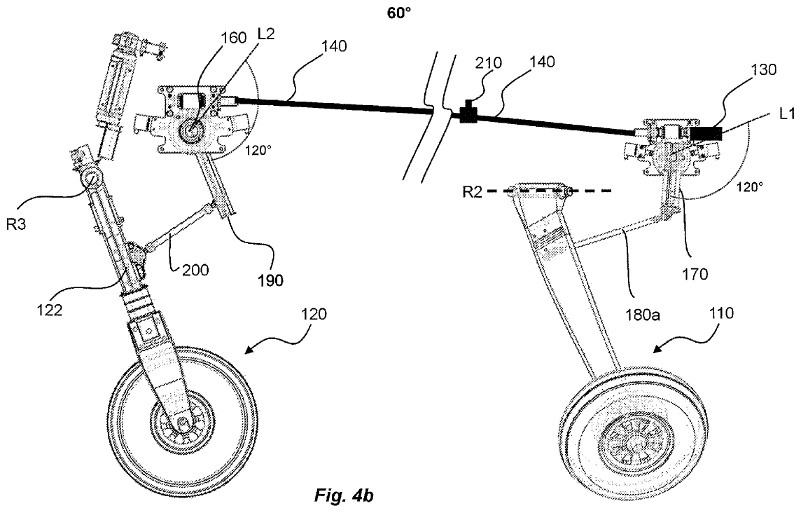

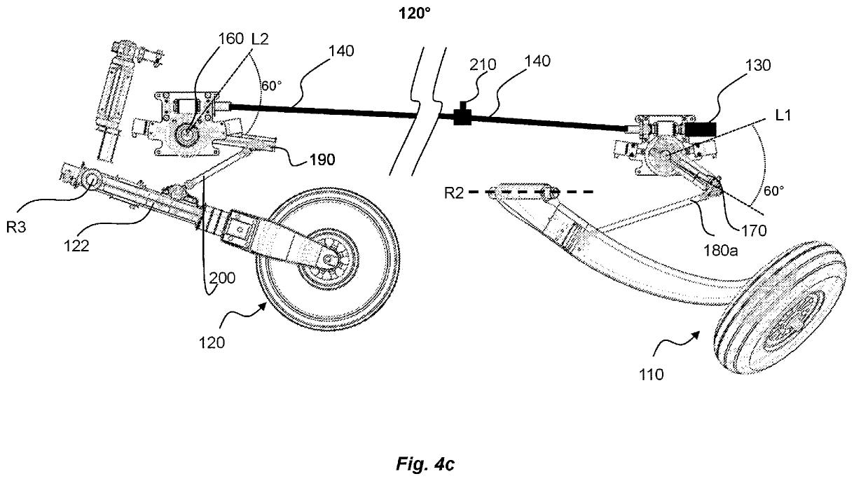

When operating the aircraft 1 the landing gear 100 can be actuated to move from a fully extended position, as is shown in FIGS. 1a and 1b, to a fully retracted position as shown in FIGS. 3a and 3b. In FIG. 3b a part of the airframe has been removed for better view of the landing gear 100. An intermediate position of the landing gear 100, close to the fully retracted position, is illustrated in FIGS. 2a and 2b.

As can be seen in FIGS. 1 to 3 each main gear leg 112a-b may be provided with a cover plate 116a-b which forms part of the aircraft airframe 3 when the landing gear 100 is arranged in the fully retracted position.

The secondary gear 120 may also be provided with a cover plate assembly 190, e.g. comprising two cover plates longitudinally and pivotably arranged on either side of the secondary gear compartment of the aircraft airframe 3, which is best shown in FIGS. 1a-1b, 2a-2b, and 3a. Alternatively, the cover plate assembly 190 may comprise a single, e.g. electrically operated, cover plate, similar to either of the cover plates 116a-b. It is also possible to provide the cover plate assembly 190 with two cover plates in series, e.g. along the longitudinal axis of the airframe, wherein one of the cover plates is configured to close after the nose gear is fully extended, thereby covering the nose gear wheel well of the airframe when the nose gear is fully extended.

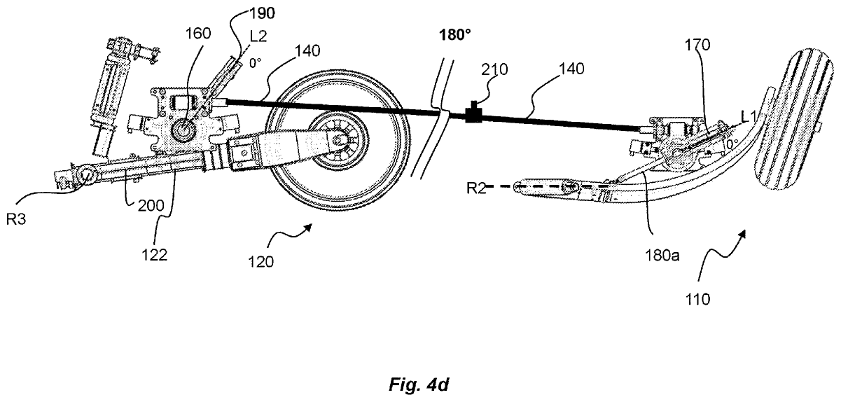

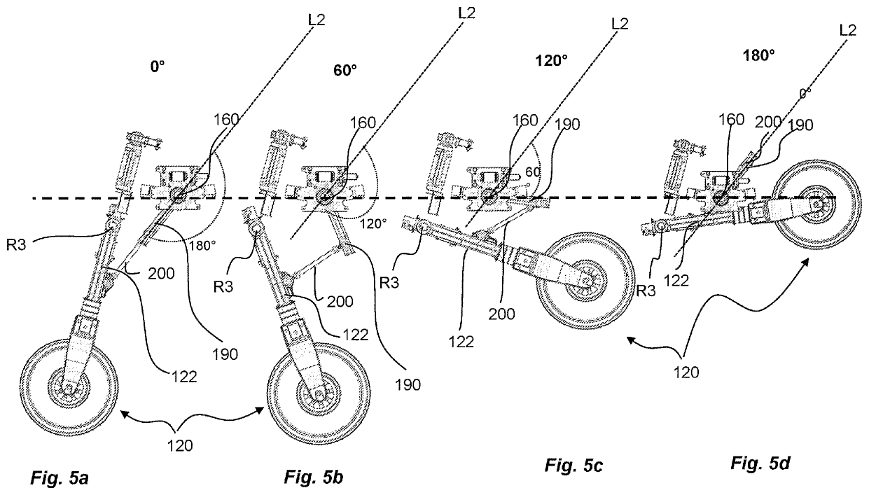

The cover plate assembly 190 may also be of a conventional type. The secondary gear 120 may be operatively coupled to the rudder pedals of the aircraft to provide for nose wheel steering. As perhaps best shown in FIGS. 5a to 5d, the secondary gear leg 122 may be operatively connected to a nose wheel steering device engaging with the gear leg 122 in the fully extended position in FIG. 5a.The landing gear 100 is operated by means of a device, configured to move the landing gear 100 from the extended position to the retracted position, or vice versa. Such device is shown in FIGS. 4a to 4d.

The device for operating the landing gear 100 comprises an electrical motor 130 in driving connection with a drive shaft 140. The drive shaft 140 may e.g. be a cardan shaft, a flexible shaft, or similar. A flexible shaft may be preferred since it may be easier to fit within the airframe 3. The drive shaft 140 is connected at one end to the main gear 110 via a first drive gear 150, and to the secondary gear 120 via a second drive gear 160. The first and second drive gears 150, 160 may preferably be formed by two identical worm gears. Each worm gear 150, 160 has an input driven by the shaft 140 and an output driving the main gear 110 and secondary gear 120, respectively. For example, the input of each worm gear 150, 160, may be provided with a reduction. Such reduction may typically be implemented by means of a planetary gearing. Further, a gear reduction may be provided in the interface between the input and the output. In one embodiment, the gear reduction on the input side (i.e. the planetary gearing) is 62:1, and the worm gear reduction (i.e. interface between input and output) is 35:1. In such example, if the electrical motor 130 is running at 6560 rpm the output side of the worm gear 150, 160 will rotate at 3.02 rpm.

Each worm gear may be a so called open worm gear. An open worm gear is not enclosed in a casing. Therefore it has a lower mass and is more compact that a standard worm gear. Still an open worm gear provides for high reliability and is therefore suitable for light sport aircraft.

Although the electrical motor 130 is shown in FIGS. 4a to 4d as being connected to the shaft 140 close to worm gear 150, it should be appreciated it can be operatively connected to the shaft 140 and/or worm gears 150, 160 at different positions in the device.

Preferably the drive shaft 140 is arranged centrally along the aircraft, such that it runs longitudinally backwards from the nose gear 120.

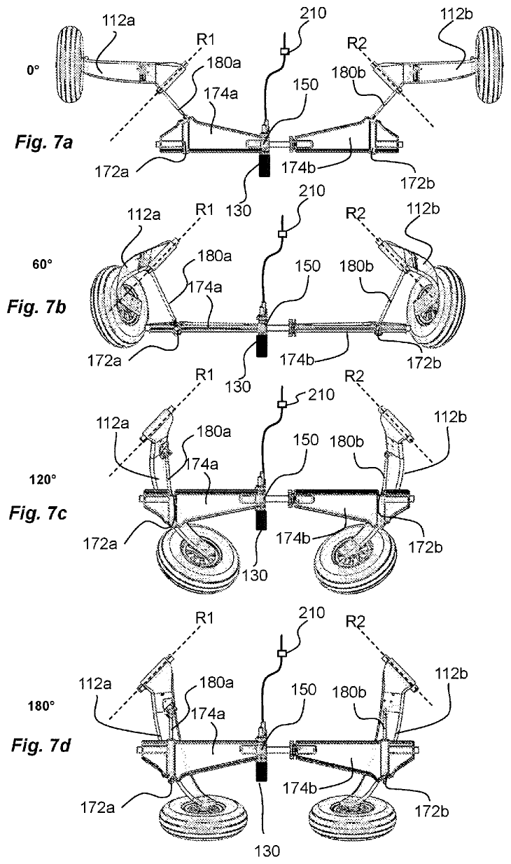

The output of the first worm gear 150 is in driving connection with a main gear crank 170. The main gear crank 170 may be formed in one piece, extending laterally and symmetrically on both sides of the first drive gear 150, as best shown in FIGS. 7a to 7d. The main gear crank 170 is in turn connected to the main gear legs 112a-b via a respective linkage 180a-b.

In a similar manner the output of the second worm gear 160 is in driving connection with a secondary gear crank 190. The secondary gear crank 190 is preferably formed in one rod-like piece. The secondary gear crank 190 is in turn connected to the secondary gear leg 122 via a secondary linkage 200.

The main gear crank 170 and the secondary gear crank 190 may preferably be made of carbon fiber, which has excellent light weight and strong capabilities, however also other conventional aircraft materials could be used.

The drive shaft 140 is further provided with a manual drive unit 210 which allows manual rotation of the drive shaft 140, and hence emergency deployment of the landing gear 100, in the unlikely event that the electrical motor or the electrical system operatively connected to the electrical motor fails during flight when the landing gear is retracted. In an emergency, a gear extension tool may be connected to the manual drive unit 210, after which the pilot in command rotates the gear extension tool until the landing gear is fully extended.

When the electrical motor 130 is activated the drive shaft 140 will turn around its longitudinal axis whereby the secondary crank 190 will rotate accordingly. This is due to the fact that the secondary crank 190 is connected to the output of the second drive gear 160. As the secondary crank 190 rotates the linkage 200 will be forced to rotate as well. For accomplishing the desired movement of the secondary gear leg 122, the secondary linkage 200 is pivotally attached to the secondary crank 190. Also, the linkage 200 is allowed to rotate relative the secondary gear leg 122.

Hence, each of the main gear crank(s) 170 and the secondary gear crank 170 is arranged to be driven to rotate around its connection to the associated worm gear 160, 150 when said worm gear is operated. The number of degrees of rotation between the fully extended position and the fully retracted position are the same for both the main crank 170 and the secondary crank 190, as shown with reference to FIGS. 4a to 4d. Preferably, the number of degrees of rotation between the extended and the retracted position is 180°, as will be further elucidated below. In FIG. 4a the landing gear is shown in its fully extended position. In this position the extension of the respective linkage 180a,b extends along a longitudinal axis L1 which intersects a lateral axis extending through the centre of the associated worm gear 150. Similarly, the extension of the secondary linkage 200 extends along a longitudinal axis L2 which intersects a lateral axis extending through the centre of the associated worm gear 160. Hence, in FIG. 4a the respective linkage 200 and 180a, b form a 0° to its associated longitudinal axis L1, and L2, respectively. In FIGS. 4a to 4d the lateral axes extending through the centre of the associated worm gears are not shown since FIGS. 4a to 4d show a side view of the device.

FIG. 4b shows a situation where the respective cranks 190 and 170 have been rotated 60° in relation to their respective longitudinal axis L2, and L1 by the mutually connected associated worm gears 150, 160.

FIG. 4c shows a situation where the respective cranks 190 and 170 have been rotated 120° in relation to their respective longitudinal axis L2, and L1 respectively, by the mutually connected associated worm gears 150, 160.

FIG. 4d shows a situation where, the landing gear is fully retracted, wherein the respective cranks 190 and 170 have been rotated 180° in relation to their respective longitudinal axis L2, and L1 by the mutually connected associated worm gears 150, 160. Hence, the respective linkage 180a,b and 200 are now yet again aligned with the respective longitudinal axis L1, and L2.

FIGS. 5a to 5d shows the same situations as described in view of FIGS. 3a to 3d from the side, but only for the secondary gear 120.

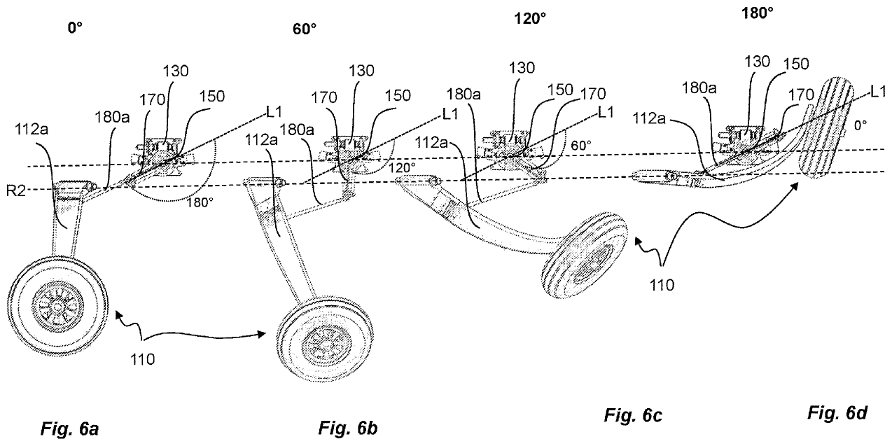

For further understanding of the deployment of the main gear 110 reference is made to FIGS. 6a-6d and 7a-7d. FIGS. 6a to 6d show the same main gear positions as described in view of FIGS. 4a to 4d. As is shown in FIGS. 4d, 6d the linkage 180a, when the main gear 110 is arranged in the retracted position, extends along a longitudinal axis L1 which intersect the lateral axis running through the centre of the drive gear 150. This is a very beneficial construction, since the linkage 180a will consequently be locked against unintentional movement. Should the linkage 180a extend off-centre, any axial force applied to the linkage 180a would possibly result in a rotational movement. However, the presented design avoids such problem. As may be observed in FIGS. 6a to 6d the linkage 180a also extends along the axis L1 in a fully extended position.

FIGS. 7a to 7d respectively shows a top view of FIGS. 6a to 6d, whereby both sides of the main gear are shown. Each main gear leg 112a-b is rotatable around a respective rotational axis R1, R2 which is fixed relative the aircraft airframe 3. As is clear from FIGS. 4a-4d, 6a-6d, and 7a-7d when the electrical motor 130 is activated the drive shaft 140 will turn around its longitudinal axis whereby the crank 170 will rotate accordingly. As the crank 170 rotates each linkage 180a-b will be forced to rotate as well. For accomplishing the desired movement of the respective main gear leg 112a-b, each linkage 180a-b is pivotally attached to the crank 170. Also, each linkage 180a-b is allowed to rotate relative the respective main gear leg 112a-b.

Accordingly, for moving the main gear 110 to its retracted position the main gear crank 170 rotates 180°. This position is shown in FIGS. 4d, 6d and 7d. Here, the main gear crank 170 has been rotated 180° compared to what is shown in FIGS. 4a, 6a and 7a.

From the position shown in FIG. 7a, during retraction of the gear the main crank is rotated in a direction such that the connection joints between the main gear crank 170 and the linkages 180a-b moves upwards (i.e. out of the drawing) to arrive at the position shown in FIG. 7d. As each linkage 180a-b is attached to its respective main gear leg 112a-b the legs 112a-b are forced to move inwards, towards the main gear crank 170. In order to ensuring a correct positioning of the linkages 180a-b relative the main gear crank 170, the main gear crank 170 is provided with two recesses, or grooves 172a-b. This allows for the crank to accommodate the linkages when it has rotated 180°. Each groove 172a-b is dimensioned such that a linkage 180a-b may be accommodated therein.

It should be noted that the main gear crank 170 must not necessarily be provided as one piece, but it may also be provided as two separate pieces 174a-b joined together such that each piece 174a-b will rotate in the same manner as the other piece 174a-b. Such embodiment is e.g. shown in FIGS. 7a to 7d.

The secondary gear 120, e.g. the nose gear 120 of the aircraft shown in e.g. FIGS. 1a-1b, 2a to 2b, 4a-4d, 5a-5d, will be deployed in a similar manner as the main gear 110 already described, however, the nose gear leg 122 is rotated around a rotational axis R3, e.g. a lateral axis of the airframe, which is fixed relative the aircraft airframe 3. Hence, upon retracting and extracting the secondary gear 120 its associated gear leg 122 will not move laterally in the same manner as the main gear legs (rotating around axis R1 and R2 as shown in FIGS. 7a to 7d), since the axis R1 and R2 are not aligned with the lateral axis of the airframe. To this end the nose gear is already arranged laterally within the side boundaries of the airframe 3, and therefore its associated gear leg 122 does not need any lateral displacement during gear extension and gear retraction.

As mentioned above, for moving the secondary gear 120 to its retracted position the secondary gear crank 190 rotates 180°. This position is shown in FIGS. 4d, and 5d. Here, the secondary gear crank 190 has been rotated 180° compared to what is shown in FIGS. 4a and 5d. From the position shown in FIGS. 4a, and 6a the secondary crank 190 has been rotated in a direction backwards. As the linkage 200 is attached to the secondary gear leg 122 the leg 122 is forced to move backwards, towards the main gear 110. In order to ensuring a correct positioning of the linkage 200 relative the secondary gear crank 190, similarly to that of the main crank, the secondary gear crank 190 is also provided with a recess, or groove (not shown). The groove is dimensioned such that the secondary linkage 200 may be accommodated therein.

When the secondary gear 120 is arranged in the retracted position, the secondary linkage 200 extends along a longitudinal axis L2 which intersect the lateral axis extending through the centre of the second drive gear 160. As for the main gear 110 this is a very beneficial construction, since the linkage 200 will consequently be locked against unintentional movement. Should the linkage 200 extend off-centre, any axial force applied to the linkage 200 would possibly result in a rotational movement. However, the presented design avoids such problem.

Hence, for both the main gear 110 and the secondary gear 120, the following thus applies. At 180°, i.e. at fully retracted and extended position, the linkage 180a-b, 200 is forming a drag-strut and is located “over centre” relative the respective drive gear 150, 160. This results in zero torsional load applied to the drive gear 150, 160 pulling g-loading on the aircraft 1. Basically the respective crank 170, 190 creates a lock of the landing gear 100 in both the extended and retracted position.

Although the preferred degrees of rotation of the respective crank has been defined as 180° it should be appreciated that the main purpose is to place the respective linkages “over centre”, i.e. intersecting a lateral axis running through the centre of their respective worm gears, in the fully retracted position. To this end, it is not essential to rotate the cranks 180° between a fully extended position and a fully retracted position as long as the linkages attains their over centre position in the fully retracted position. However, from a robustness point of view 180° has been shown to tolerate superior g force tolerances in both the fully extended and fully retracted position.

The invention has mainly been described with reference to a few embodiments. However, as is readily understood by a person skilled in the art, other embodiments than the ones disclosed above are equally possible within the scope of the invention, as defined by the appended claims.

1. A device configured to deploy a retractable landing gear of an aircraft, the device having a main landing gear and a secondary landing gear, said device comprising an electrical motor in driving connection with a drive shaft connecting the secondary landing gear with said main landing gear.

2. The device according to claim 1, wherein the drive shaft is connected to the main landing gear by means of a first drive gear, and to the secondary landing gear by means of a second drive gear.

3. The device according to claim 2, wherein the first and second drive gears are worm gears.

4. The device according to claim 2, further comprising a main gear crank, wherein at least two separate gear legs of the main landing gear are connected to said main gear crank via a respective main gear linkage, wherein the main gear crank is connected to an output of the first drive gear.

5. The device according to claim 4, wherein each main gear linkage is pivotally connected to the main gear crank.

6. The device according to claim 4, wherein the main gear crank is provided with two spaced-apart grooves for accommodating the respective main gear linkages.

7. The device according to claim 4, wherein the main gear crank is configured to rotate between two end positions to move the main gear legs from an extended position to a retracted position, or vice versa.

8. The device according to claim 7, wherein each main gear linkage, when the main gear crank is arranged in any of its end positions, extends along a longitudinal axis (L1) intersecting the centre of the first drive gear.

9. The device according to claim 4, further comprising a secondary gear crank, wherein a secondary gear leg of the secondary landing gear is connected to said secondary gear crank via a secondary gear linkage.

10. The device according to claim 9, wherein the secondary gear crank is connected to an output of the second drive gear.

11. The device according to claim 10, wherein the secondary gear crank is configured to rotate between two end positions to move the secondary gear leg from an extended position to a retracted position, or vice versa.

12. The device according to claim 11, wherein the secondary gear linkage, when the secondary gear crank is arranged in any of its end positions, extends along a longitudinal axis (L2) intersecting the centre of the second drive gear.

13. The device according to claim 2, further comprising a manual drive unit connected to the drive shaft.

14. The device according to claim 13, wherein the manual drive unit is arranged between the first and second drive gears.

15. The device according to claim 2, wherein the first and/or second drive gears are open worm gears.

16. A retractable landing gear, comprising a main landing gear, a secondary landing gear, and a device according to claim 1.

17. The landing gear according to claim 16, wherein the main landing gear comprises at least two spaced-apart main gear legs, and wherein each main gear leg is supported by a rotational axis (R1, R2) being tilted relative a rotational axis of the main gear crank.

18. An aircraft, comprising a landing gear according to claim 16.

19. The aircraft according to claim 17, wherein each main gear leg of the main landing gear is provided with a cover plate forming part of the aircraft airframe when in a retracted position.
